(19) United States
(12) Patent Application Publication
(10) Pub. No.: US 2004/0164928 A1
(43) Pub. Date: Aug. 26, 2004

(54) Plasma display panels manufacturing method and sintering device

(76) Inventors: Hiroyasu Tsuji, Osaka (JP); Makoto Morita, Hyogo (JP); Masanori Suzuki, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/479,466

(22) PCT Filed: Jun. 9, 2003
(86) PCT No.: PCT/JP03/07253

(30) Foreign Application Priority Data
Jun. 10, 2002 (JP) 2002-168770
Jun. 10, 2002 (JP) 2002-168771

(51) Int. Cl. G09G 3/28

(52) U.S. Cl. 345/60

(57) ABSTRACT

A method of manufacturing PDPs and a firing device that allows preferable firing of panel components by controlling each setter. Transportation means 22, 23, and 24 configured by disposing rollers 22a, 23a, and 24a in a transport direction of substrate 101 allows firing of panel component 102 while transporting substrate 101 placed on setter 103. ID identification means 105 for identifying setter 103 using an ID area provided on setter 103 is provided on firing device 21. Panel components 102 are fired using this firing device 21 for controlling information such as the number of heatings of each setter 103.

### TECHNICAL FIELD

The present invention relates to methods of manufacturing plasma display panels (PDPs) which are characterized as large-screen, thin, and lightweight display devices, and firing devices employed in their manufacture.

### BACKGROUND ART

PDPs are gaining more attention recently as flat display panels since they have more advantageous features than liquid crystal panels, including faster display time, wider viewing angle, ease of manufacturing large screens, and higher display quality realized by self-light emission. PDPs are being used in an expanding range of contexts, including as displays for public places and wide-screen display devices for domestic viewing.

In a PDP, gas discharge generates ultraviolet rays, and these ultraviolet rays excite the phosphors, which then emit visible light for color display. PDP driving systems can be generally classified into AC and DC types. The electric discharge system can be classified into two types: surface discharge and opposed discharge. The AC surface discharge type that has a 3-electrode structure is the mainstream type with respect to higher definition, larger screens, and easier manufacture. The PDP of the AC surface discharge type that has a 3-electrode structure is configured with multiple pairs of display electrodes aligned in parallel on one substrate, address electrodes disposed on the other substrate in a way such that to cross the display electrodes, a barrier rib, and a phosphor layer. Since the phosphor layer can be made relatively thick, this type of PDP is appropriate for color displays using phosphors.

The method of manufacturing PDPs includes the steps of forming panel components such as electrode, dielectric and phosphor one after another mainly using the step of forming a thick film on the surface of the front substrate and rear substrate by repeating printing, drying and firing; and overlaying and sealing the front substrate and rear substrate on which these panel components are formed. In the above steps, a firing device is used for drying and firing.

As for the firing device, a so-called roller-hearth kiln, fit for mass production, is employed. The roller-hearth kiln has its transport means configured by aligning multiple rollers in the direction of transportation of the substrate. While firing the panel components formed on the front and rear substrates, the substrates are placed on a support substrate called a setter (this state is hereafter called the firing target) during transportation for firing to prevent damage to each substrate by the transportation means. In addition, uniform heating of the entire substrate is important when firing the panel components.

However, firing defects occur on the panel components in this type of firing device that seem to be caused by non-uniform heating of the substrate during firing. This appears to be caused by thermal deformation that accumulates in the setter due to the repeated use of the same setter. Non-uniform contact of the setter and rollers, which are the transportation means, impedes smooth transportation by meander or deviation, resulting in non-uniform heating while firing the substrate.

The present invention is designed to solve this disadvantage, and aims to offer a method of manufacturing PDPs and a firing device employed in the manufacture that achieve satisfactory firing of the panel components by controlling each setter.

### DISCLOSURE OF INVENTION

To achieve the above object, a method of manufacturing PDPs of the present invention includes the steps of firing a substrate at a predetermined temperature while the substrate on which the panel components are formed is placed on a setter and transported by a transportation means configured with multiple rollers; and identifying and controlling each setter based on identification information in an ID area provided on each setter.

This method allows the control of information on the setter to be used in firing for identifying the number of use in the firing process so as to solve a problem of non-uniform firing due to thermal deformation of the setter itself. Accordingly, the method of manufacturing high-quality PDPs at a high yield is achievable.

### BRIEF DESCRIPTION OF THE DRAWINGS

FIG. 1 is a sectional perspective view of a PDP structure.

FIG. 2 is a process chart of a method of manufacturing PDPs in accordance with an exemplary embodiment of the present invention.

FIG. 3 is a sectional view of a structure of a firing device for PDPs in accordance with the exemplary embodiment of the present invention.

FIG. 4 is an example of an individual identification area of a setter in the firing device for PDPs in accordance with the exemplary embodiment of the present invention.

FIG. 5 is a brief configuration of an identification means in the firing device for PDPs for the individual identification area in accordance with the exemplary embodiment of the present invention.

FIG. 6 is a brief configuration of a positioning means in an elevating means of the firing device for PDPs in accordance with the exemplary embodiment of the present invention.

### DETAILED DESCRIPTION OF PREFERRED EMBODIMENT(S)

An exemplary embodiment of the present invention is described below with reference to drawings.

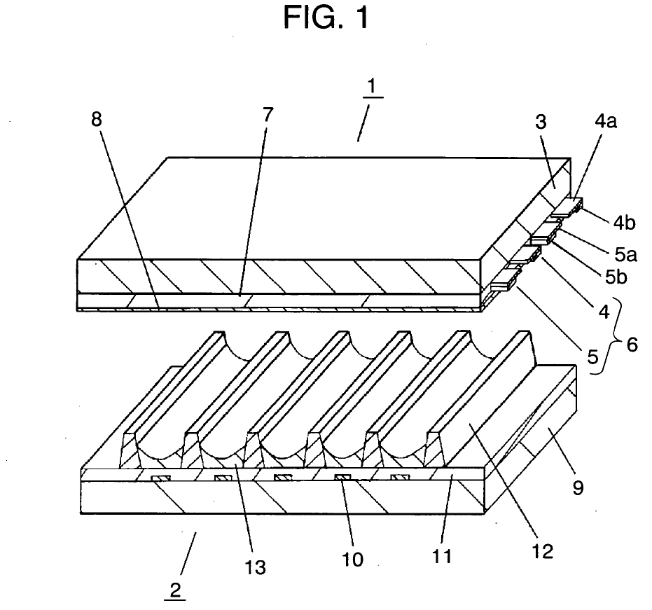

FIG. 1 shows the structure of a PDP manufactured using a method of manufacturing PDPs of the present invention. The PDP is configured with front substrate 1 and rear substrate 2. Front substrate 1 consists of striped display electrode 6 including a pair of scanning electrode 4 and susutain electrode 5 formed on transparent insulating substrate 3 such as a glass substrate made of borosilicate sodium glass using the float process, dielectric layer 7 covering display electrodes 6, and protective film 8 made of MgO formed on dielectric layer 7. Scanning electrode 4 and sustain electrode 5 are, for example, configured by transparent electrodes 4a and 5a made of a transparent conductive material such as ITO and bus electrodes 4b and 5b made such as of Ag which are electrically coupled to these transparent electrodes 4a and 5a.

Rear substrate 2 consists of address electrode 10 formed in a direction orthogonal to display electrode 6 on substrate 9 in a way facing substrate 3 of front substrate 1, dielectric layer 11 covering this address electrode 10, multiple striped barrier ribs 12 parallel to and between address electrodes 10 on dielectric layer 11, and phosphor layer 13 formed between these barrier ribs 12. For color display, red, green, and blue are in general disposed sequentially in phosphor layers 13.

Sealing member (not illustrated) forms a seal around front substrate 1 and rear substrate 2 such that display electrode 6 and address electrode 10 cross at right angles and that a small discharge space is secured in between. In the discharge space, discharge gas such as a mixture of neon (Ne) and xenon (Xe) is enclosed. The discharge space is partitioned into multiple blocks by barrier ribs 12. Multiple discharge cells are thus formed between barrier ribs 12, and these discharge cells are unit luminescence regions.

Electric discharge occurs as a result of the voltage periodically applied to address electrode 10 and display electrode 6. The ultraviolet rays generated by this electric discharge irradiate phosphor layer 13, where they are converted to visible light for image display.

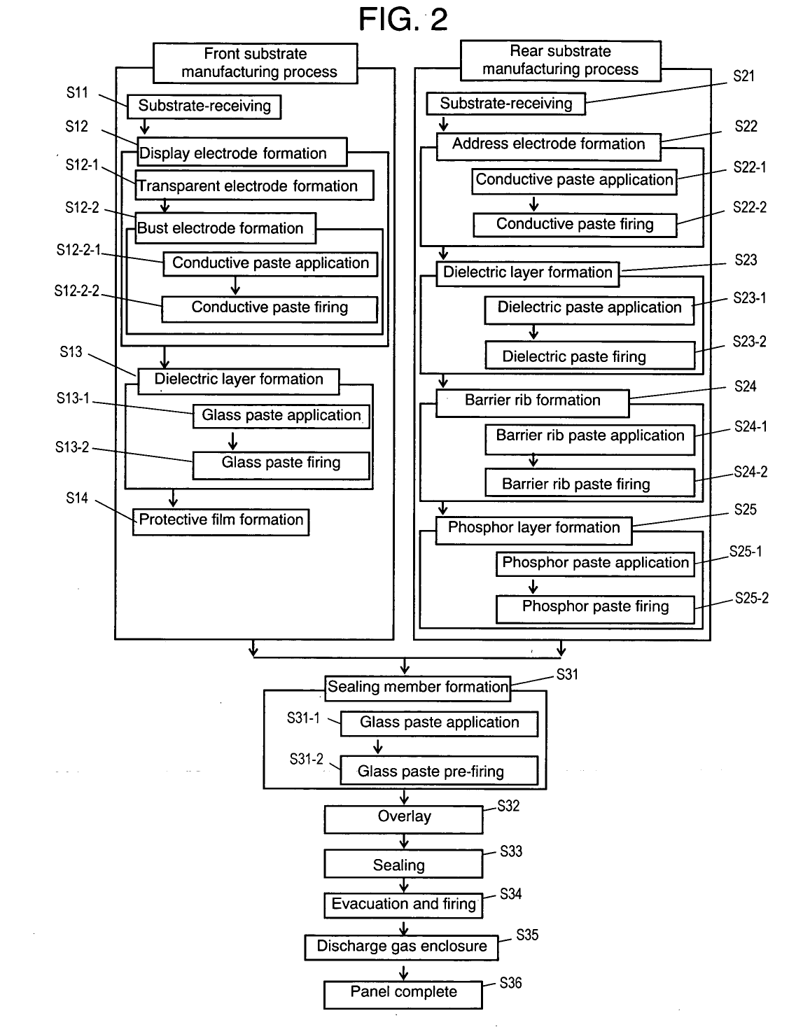

Next, the method of manufacturing the PDP as configured above is described with reference to FIG. 2, which shows the steps in the method of manufacturing PDPs in the exemplary embodiment of the present invention.

First, the process of manufacturing the front substrate, i.e., front substrate 1, is described. After the substrate-receiving step (S11) to receive substrate 3, the step of forming display electrodes (S12) is executed to form display electrodes 6 on substrate 3. The step of forming display electrodes (S12) includes the step of forming transparent electrodes (12-1) for forming transparent electrodes 4a and 5a, and the subsequent step of forming bus electrodes for forming bus electrodes 4b and 5b. The step of forming bus electrodes (S12-2) includes the step of applying conductive paste (S 12-2-1) for applying conductive paste such as Ag by screen-printing and the step of firing conductive paste (S12-2-2) for firing the conductive paste applied. Then, after the step of forming display electrodes (S12), the step of forming dielectric layer (S13) is executed to form dielectric layer 7 to cover display electrodes. The step of forming dielectric layer (S13) includes the step of applying glass paste (S13-1) for applying paste including lead-system glass material [whose composition is, for example, 70 wt % lead oxide (PbO), 15 wt % boron oxide (B₂O₃), and 15 wt % silicon oxide (SiO₂)] by screen-printing, and the step of firing glass paste (S13-2) for firing the glass material applied. Then, the step of forming protective film (S14) is executed to form protective film 8 such as of magnesium oxide (MgO) by vacuum deposition on the surface of dielectric layer 7 to complete the manufacture of front substrate 1.

Next, the process of manufacturing the rear substrate, i.e., rear substrate 2, is described. After the step of receiving (S21) for receiving substrate 9, the step of forming address electrodes (S22) is executed to form address electrodes 10 on substrate 9. This step (S22) includes the step of applying conductive paste (S22-1) for applying conductive paste such as of Ag by screen-printing, and a subsequent step of firing the applied conductive paste (S22-2). The step of forming dielectric layer (S23) is then executed to form dielectric layer 11 on address electrode 10. This step (S23) includes the step of applying dielectric paste (S23-1) for applying dielectric paste containing titanium oxide (TiO₂) particles and dielectric glass particles typically by screen-printing, and a subsequent step of firing the applied dielectric paste (S23-2).

Then, the step of forming barrier ribs (S24) for forming barrier ribs 12 on dielectric layer 11 between address electrodes 10 is executed. This step (S24) includes the step of applying barrier paste (S24-1) for applying barrier paste containing glass particles typically by printing and a subsequent step of firing barrier paste (S24-2) for firing the applied barrier paste. The step of forming phosphor layer (S25) for forming phosphor layer 13 between barrier ribs is then executed. This step (S25) includes the step of applying phosphor paste (S25-1) for making color phosphor paste of red, green, and blue, and applying the phosphor paste of these colors between barrier ribs 12, and the subsequent step of firing the applied phosphor paste (S25-2).

Rear substrate 2 is completed through these steps.

Next, the step of sealing front substrate 1 and rear substrate 2 manufactured as above and the step of evacuating and enclosing discharge gas are described.

A step of forming sealing member (S31) for forming sealing member made of glass frit on one or both of front substrate 1 and rear substrate 2 is executed. This step (S31) includes the step of applying glass paste for sealing (S31-1) and the step of pre-firing glass paste (S31-2) for tentatively firing the applied glass paste to remove the resin constituent in the glass paste applied. Then, the overlaying step (S32) is executed to overlay two substrates such that display electrodes 6 on front substrate 1 and address electrodes 10 on rear substrate 2 cross at right angles. The sealing step (S33) is then executed to soften the sealing member by heating both substrates overlaid for sealing. After the evacuating and firing step (S34) is executed to fire the panel while evacuating a small discharge space created between the sealed substrates, the step of enclosing discharge gas (S35) is executed to enclose discharge gas under a predetermined pressure so as to complete the PDP (S36).

In the manufacture of the PDP, as described above, a firing process is often applied when forming panel components such as bus electrodes 4b and 5b, dielectric layer 7, address electrode 10, dielectric layer 11, barrier rib 12, phosphor layer 13, and sealing member (not illustrated). A firing device employed in these firing processes is described below.

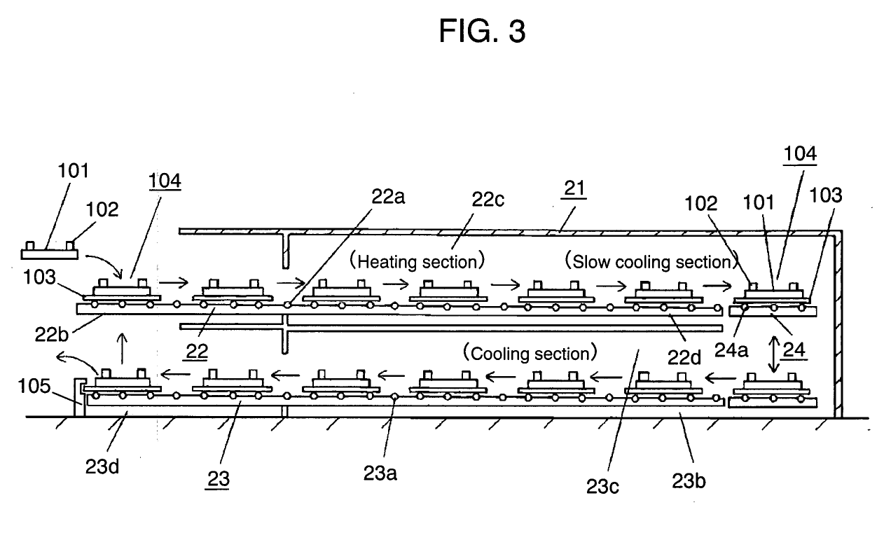

FIG. 3 is a sectional view of the firing device used in the method of manufacturing PDPs in the exemplary embodiment of the present invention. Firing device 21 includes outward transportation means 22 in which multiple rollers 22a are aligned in the transporting direction, return transportation means 23 in which multiple rollers 23a are aligned in the transporting direction, and elevating means 24 in which multiple rollers 24a are aligned in the transporting direction and also configured so as to enable rollers 24a to be elevated between outward transportation means 22 and return transportation means 23.

Substrate 101, i.e., front substrate 1 or rear substrate 2, of the PDP on which panel components 102 such as bus electrodes 4b and 5b, dielectric layer 7, address electrode 10, dielectric layer 11, barrier rib 12, phosphor layer 13, or sealing member (not illustrated) are formed is placed on setter 103 which is a support substrate, and transported by outward transportation means 22. Setter 103 is provided so as to prevent damage to substrate 101. A structure in which substrate 101 is placed on setter 103 is hereafter called firing target 104.

In the above configuration, a characteristic of the exemplary embodiment is that an individual identification area, i.e., ID area, for self-identification is provided on setter 103, and firing device 21 has individual identification area recognition means 105, i.e., ID area identification means, for identifying information in the individual identification area of setter 103.

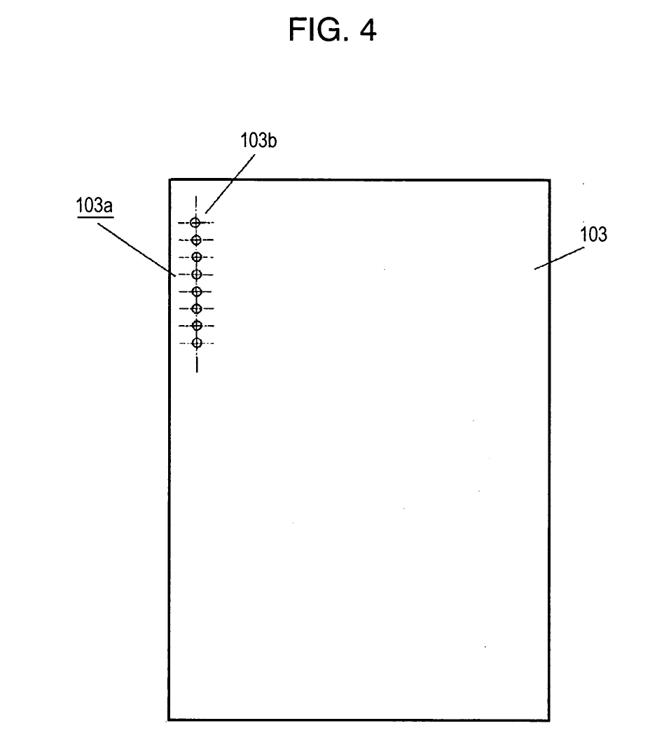

FIG. 4 shows an example of the individual identification area provided on setter 103. One example of the individual identification area on setter 103 is configured with a change in optical transmittance such as a combination of through holes (which naturally has a high optical transmittance) and other parts. Individual identification area 103a is provided on the periphery of setter 103. This individual identification area 103a is configured by a combination of the presence of through holes 103b provided on setter 103. For example, if the combination of the number of through holes is practically changed for each setter 103 at n number of points to provide through holes, individual identification information can be provided to 2 ⁿsetters.

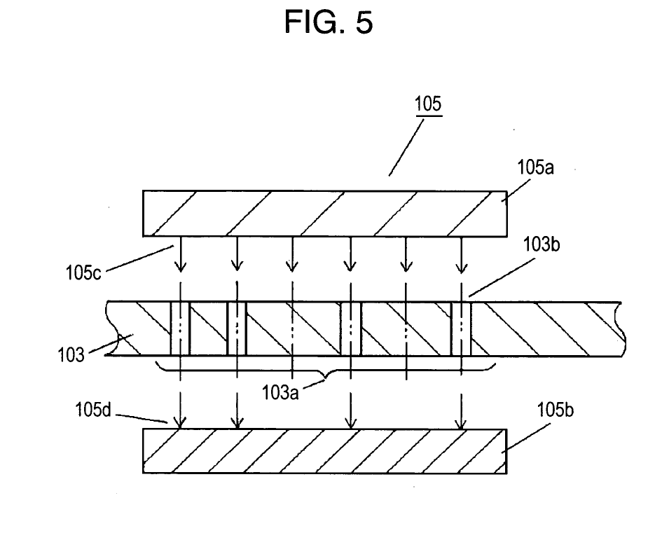

FIG. 5 shows an example of individual identification area recognition means in the PDP firing device. As shown in FIG. 5, individual identification area recognition means 105 can be configured by combining light-emitting element 105a and light-receiving element 105b disposed facing each other with individual identification area 103a of setter 103 in between. Exiting light 105c emitted from light-emitting element 105a passes via through hole 103b, for example, provided on individual identification area 103a of setter 103, and enters light-receiving element 105b as transmitted light 105d. Each setter 103 can be identified by its pattern of transmitted light 105d that enters. If eight recognition points such as through holes 103a are provided, 2⁸ sheets of setters are identifiable.

A firing process for firing firing target 104 using setter 103 having individual identification area 103a and firing device 21 having individual identification area recognition means 105 as mentioned above is described below with reference to FIG. 3. First, firing target 104 is placed on transport start 22b of outward transportation means 22. Outward transportation means 22 guides firing target 104 to upper passage 22c of firing device 21, and heating means such as a heater (not illustrated) provided inside upper passage 22c heats firing target 104 to a predetermined firing temperature in the heating section for firing, while the firing target continues to be transported by outward transportation means 22. Then, in a slow-cooling section, firing target 104 is cooled while being transported toward end 22d of outward transportation means 22. Firing target 104 is further transported beyond transport end 22d of outward transportation means 22, and reaches elevating means 24. Firing target 104 reaching elevating means 24 is lowered to the level connected to return transportation means 24 by elevating means 24, and transferred to transport start 23b of return transportation means 23 by being transported in the reverse direction to the transportation direction of outward transportation means 22. Then, return transportation means 23 transports firing target 104 in lower passage 23c, i.e., the cooling section, to cool firing target 104 to normal temperature. When firing target 104 reaches transport end 23d of return transportation means 23, substrate 101 being fired is taken out from setter 103. Empty setter 103 moves to transport start 22b of outward transportation means 22 in the upper stage again, and next substrate 101 is placed and guided on upper passage 22c for firing.

Here, individual identification area recognition means 105 provided in firing device 21 recognizes the individual identification information of setter 103 in firing target 104 reaching transport end 23d. A separately provided processor (not illustrated) accumulates recognized individual identification information and monitors the history of setter 103 such as the number of firings and heatings in firing processes for which panel component. A threshold, such as for the number of uses, is set for setter 103, related to the number of firings; and setter 103 whose information identified at transport end 23d exceeds this threshold is not reloaded to the upper passage. Instead, this setter 103 is ejected for maintenance or disposal. Such system for excluding setter 103 used beyond the predetermined number of firings allows the accumulated thermal deformation of setter 103 due to repeated firing to be kept below a predetermined level. As a result, occurrence of meandering or deviation during transportation, thought to be caused by deformation of setter 103 due to thermal deformation accumulated during repeated firings is reduced, achieving smooth transportation. Accordingly, panel component 102 can be fired in an optimal state.

Moreover, the firing device of the present invention has a function for correcting positional deviation of setter 103 for ensuring smooth transportation of setter 103. A positioning means is provided on transportation means as the positional deviation correcting function, and slidability between the roller and setter is also improved.

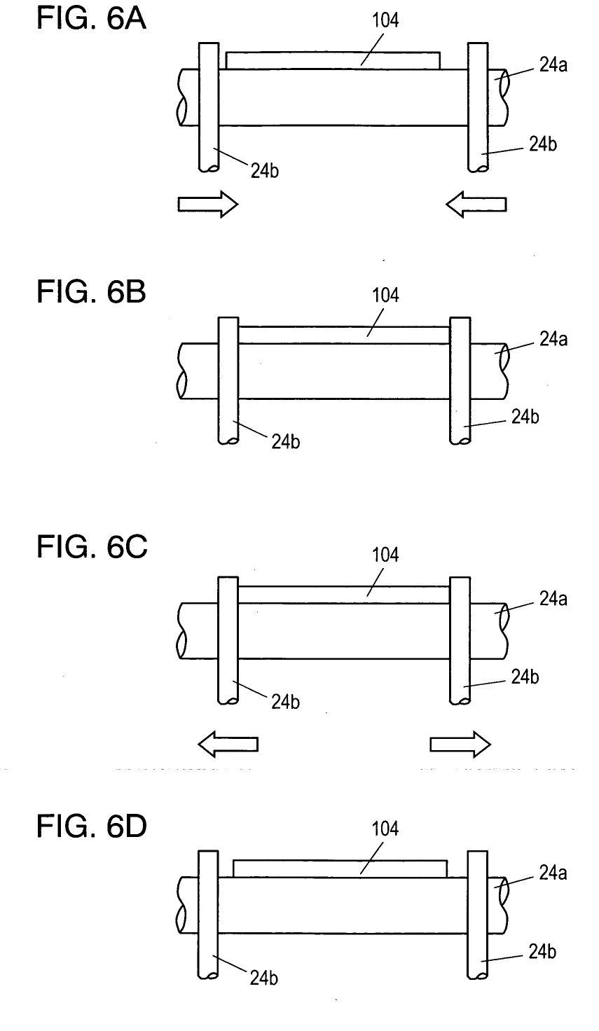

FIG. 6 is a schematic view of the positioning means provided in the elevating means of the firing device in the exemplary embodiment of the present invention. The position of firing target 104, including setter 103 on the rollers, is more likely to deviate when changing direction in the transportation means. For example, positional deviation often occurs at a point of changing from horizontal transportation to vertical transportation. FIG. 6 is an example of the positioning means provided on elevating means 24, seen from the front with respect to the transportation of firing target 104 by elevating means 24. In FIG. 6, the shape of firing target 104 is simplified to facilitate understanding. When firing target 104 is loaded to elevating means 24, as shown in FIG. 6(a), positioning guide 24b such as a pin between rollers 24a contacts setter 103 of firing target 104. At this point, firing target 104 is positioned while it is being placed on rollers 24a. Positional deviation of firing target 104 also often occurs when firing target 104 is lowered by elevating means 24. Therefore, firing target 104 is lowered while being positioned by positioning guide 24b, as shown in FIG. 6(c); and positioning by positioning guide 24b is then released, as shown in FIG. 6(d). Firing target 104, released from positioning guide 24b, is moved and transferred from elevating means 24 to return transportation means 23.

To apply the above positioning, the firing device of the present invention adopts materials in optimal combination with respect to the relative slidability of rollers 22a, 23a, and 24a, and setter 103. A specific example of combination of materials which demonstrates good relative slidability is the use of a material mainly containing silicon carbide (SiC) for rollers 22a, 23a, and 24a (hereafter SiC rollers) and crystal glass with a low expansion coefficient, such as Neoceram N-0 (product name) by Nippon Electric Glass, for setter 103 (hereafter ‘Neoceram setter’).

The SiC roller is formed into the roller shape after mixing silicon carbide (SiC) powder and binder, and then silicon (Si) material is added and fired to melt the silicon (Si) material into the roller. Constituents are defined by 2 to 50 wt % of silicon (Si) metal, silicon (Si) silicon monocarbide (SiC) containing 98 to 50 wt % of silicon carbide (SiC). Neoceram contains 50 to 65 wt % of silicon oxide (SiO₂), 1 to 15 wt % of aluminum oxide (Al₂O₃), and a very small amount of lithium (Li).

Positioning of setter 103, as described above, eliminates the need for lifting firing target 104 from rollers 24a, and thus several elevating and lowering steps for firing target 104 with respect to positioning are eliminated. In addition, the positioning means can adopt a simple structure. Still more, since rollers 24a and setter 103 demonstrate good slidability, abrasion powder generated between these members can be reduced. Accordingly, the PDP with higher quality and yield can be manufactured by eliminating the mixture of foreign particles with the PDP components.

In the above exemplary embodiment, the positioning means is provided on the elevating means. Since this positioning means can be easily configured, it can be easily provided mainly at areas where positional deviation occurs frequently in the transportation means.

The method of manufacturing the PDP and the firing device of the present invention thus suppress positional deviation of the firing target due to deformation of the setter by controlling individual information such as the heat history of each setter. Furthermore, the positional deviation of the firing target is corrected by providing the positioning means. Accordingly, firing targets are uniformly fired so as to achieve uniform quality.

It is apparent that individual control of the setters and positioning can be integrated or separately implemented.

### INDUSTRIAL APPLICABILITY

The present invention controls each setter for achieving a method of manufacturing PDPs and the firing device used in the manufacture that enables preferable firing of panel components.

Reference numerals in the drawings

1 Front substrate

2 Rear substrate

3, 9, 101 Substrate

4 Scanning electrode

5 Sustain electrode

4a, 5a Transparent electrode

4b, 5b Bus electrode

6 Display electrode

7, 11 Dielectric layer

8 Protective film

10 Address electrode

12 Barrier rib

13 Phosphor layer

21 Firing device

22 Outward transportation means

22a, 23a, 24a Roller

22b, 23b Transport start

22c Upper passage

22d, 23d Transport end

23 Return transportation means

23c Lower passage

24 Elevating means

102 Panel component

103 Setter

103a Individual identification area

103b Through hole

104 Firing target

105 Individual identification area recognition means

105a Light-emitting element

105b Light-receiving element

105c Exiting light

105d Transmitted light

1. A method of manufacturing a plasma display panel, said method comprising:
firing a panel component at a predetermined temperature while transported by transportation means configured with a plurality of rollers, said panel component being formed on a substrate, and said substrate being placed on a setter; and
identifying and controlling said setter using identification information in an ID area provided on said setter.

2. The method of manufacturing a plasma display panel as defined in claim 1, wherein said step of identifying and controlling the setter is a step of controlling history information in a step of firing the setter.

3. The method of manufacturing a plasma display panel as defined in claim 2, wherein said history information is the number of firings in the past in the step of firing the setter.

4. The method of manufacturing a plasma display panel as defined in one of claims 1 to 3, wherein said ID area is configured with a combination of a plurality of points with different optical transparency.

5. The method of manufacturing a plasma display panel as defined in claim 4, wherein a point with high transparency in said plurality of points with different optical transparency is a through hole.

6. A firing device for a plasma display panel comprising:
transportation means configured by aligning at least a plurality of rollers in a transport direction of a substrate;
firing means for heating and firing the substrate on which a panel component is formed, said substrate being placed on a setter and transported by said transportation means; and
ID identification means for identifying and controlling said setter using an ID area provided on said setter.

7. The firing device for a plasma display panel as defined in claim 6, wherein said ID area provided on the setter is configured by a combination of a plurality of points with different optical transparency, and said ID area identification means is configured by a combination of a light-emitting element and a light-receiving element disposed facing each other with the ID area on the setter in between.

8. The firing device for a plasma display panel as defined in claim 7, wherein a point with high transparency in said plurality of points with different optical transparency is a through hole.

9. The firing device for a plasma display panel as defined in claim 8 further comprising positioning means for restricting a position of the setter on the transportation means at a predetermined position on the transportation means.

10. The firing device for a plasma display panel as defined in claim 9, wherein said positioning means positions the setter by making the setter slide on the rollers of the transportation means.
